(19) United States
(12) Patent Application Publication
(10) Pub. No.: US 2006/0244730 A1
(43) Pub. Date: Nov. 2, 2006

(54) Keypad arrangment for a hand-held device

(76) Inventors: Mehrban Jam, Fremont, CA (US); Cyril Brignone, Mountain View, CA (US); Salil Pradhan, San Jose, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/117,916

(22) Filed: Apr. 29, 2005

(51) Int. Cl. G09G 5/00

(52) U.S. Cl. 345/169

(57) ABSTRACT

A first aspect of the present invention is a keypad arrangement for a device. The keypad arrangement includes a molded portion and an underlying display portion coupled to the molded portion capable of dynamically displaying a plurality of different legends whereby each of the plurality of legends is associated with at least one functionality of the device.

### FIELD OF THE INVENTION

The present invention relates generally to hand-held devices and particularly to a keypad arrangement for a hand-held device.

### BACKGROUND OF THE INVENTION

Hand-held devices such as cellular telephones and personal digital assistants (PDAs) are becoming increasingly functional as modern electronics allows more and more chips to be put in these devices. This trend of miniaturization will continue. However, the users of these devices remain the same size. This creates a problem in terms of interface technology. The keypads can only be miniaturized to the extent that they are useable by human beings.

Modern cellular telephones clearly illustrate this clash of miniaturization and human interface. FIG. 1 shows a block diagram of a conventional cellular telephone 100. The cellular telephone 100 includes a keypad 110 and a Liquid Crystal Display (LCD) 120. The keypad 110 contains conventional telephone keys 111 whereby each key has a separate alpha-numeric association.

Modern cellular telephones are not only used for voice communication but are also used for instant messaging, web browsing, viewing video clips, taking photographs, etc. As a result the standard numeric telephone keypad 110 is crammed with multiple legends and symbols. Most of the time the user has to cycle through the keypad 110 legends by pressing the key multiple times while looking at the LCD 120 above the keypad 110. This is tedious and cumbersome.

Accordingly, what is needed is a more user-friendly approach to the miniaturization problem. The approach should be simple, inexpensive and capable of being easily adapted to existing technology. The present invention addresses this need.

### SUMMARY OF THE INVENTION

A first aspect of the present invention is a keypad arrangement for a device. The keypad arrangement includes a molded portion and an underlying display portion coupled to the molded portion capable of dynamically displaying a plurality of different legends whereby each of the plurality of legends is associated with at least one functionality of the device.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 is a block diagram of a cellular phone.

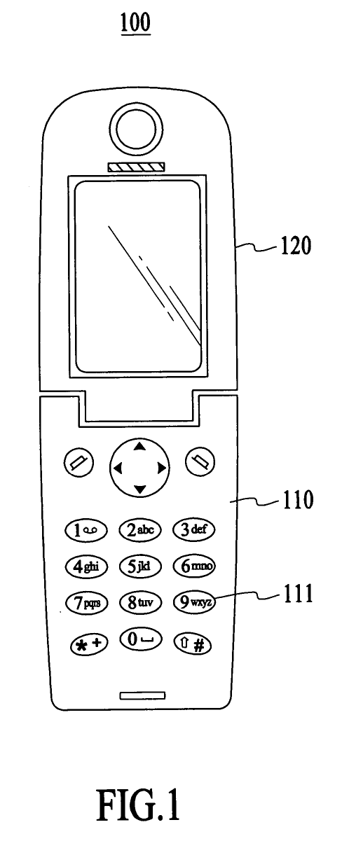

FIG. 2 is a block diagram of a hand-held device in accordance with an embodiment of the present invention.

FIG. 3 is a keypad arrangement in accordance with an embodiment of the present invention.

FIG. 4 is an alternate view of a keypad arrangement in accordance with an embodiment of the present invention.

FIG. 5 is an illustration of a hand-held device configuration in accordance with an embodiment of the present invention.

FIG. 6 illustrates a cell phone legend in accordance with an embodiment of the present invention.

FIG. 7 illustrates a MP3 player legend in accordance with an embodiment of the present invention.

FIG. 8 illustrates a digital camera legend in accordance with an embodiment of the present invention.

FIG. 9 illustrates a text messaging legend in accordance with an embodiment of the present invention.

### DETAILED DESCRIPTION

The present invention relates to a keypad arrangement for a hand-held device. The following description is presented to enable one of ordinary skill in the art to make and use the invention and is provided in the context of a patent application and its requirements. Various modifications to the embodiments and the generic principles and features described herein will be readily apparent to those skilled in the art. Thus, the present invention is not intended to be limited to the embodiment shown but is to be accorded the widest scope consistent with the principles and features described herein.

As shown in the drawings for purposes of illustration, a keypad arrangement for a hand-held device is disclosed. In an embodiment, the hand-held device is a device such as a cellular telephone or personal digital assistant. Accordingly, varying embodiments of the present invention replace the permanent keys of the conventional device with a transparent keypad that functions as a lens to show an underlying touch screen LCD. As a result, the legends being displayed on the underlying LCD can be dynamically changed through software control based on the context and functionality of the desired application. Consequently, a more user friendly interface is achieved.

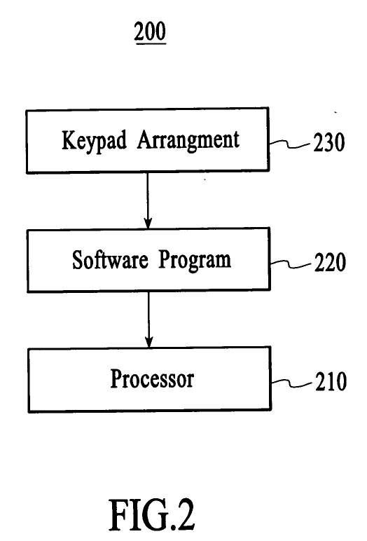

FIG. 2 is a high-level illustration of a hand-held device 200 in accordance with an embodiment. In this embodiment, the hand-held device 200 includes a processor 210, software programs 220 and a keypad arrangement 230. The processor 210 runs the software programs 220 whereby the software programs 220 are associated with the different functionalities of the hand-held device 200. It should be noted that the software programs 220 can be any of a variety of software programs that are known to one of ordinary skill in the art.

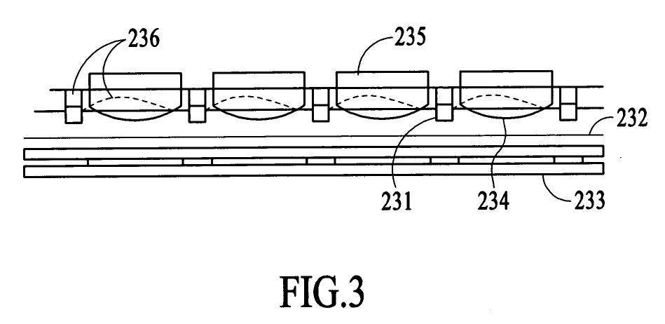

FIG. 3 is a more detailed illustration of the keypad arrangement 230 in accordance with an embodiment. The keypad arrangement 230 includes a support grid 231, a touch-screen 232, an LCD 233, touch-screen contact points 234, molded keys 235, and springs 236. The support grid 231 supports the molded keys 235 in order to prevent the molded keys 235 from touching the LCD 233 while the keys 235 are not being pushed. In an embodiment, the molded keys 235 are formed by molding clear plastic in the form of keys 235 on top and a convex lens on the bottom. Each key 235 is supported by curved leaf springs 236 resting on top of the support grid 231. When a key 235 is pressed, the springs 236 snap inward and the bottom of the key 235 presses against the touch-screen 232.

In an embodiment, the touch-screen 232 is a screen that is sensitive to the touch or the application of pressure. Touch screens are very resistant to harsh environments where keyboards might eventually fail. Applications are typically very specialized and greatly simplified so they can be used by anyone.

There are two primary technologies, resistive and capacitive, that are used for touch screens. Both use a clear glass panel overlaid onto the LCD screen. The resistive method is completely pressure sensitive. It uses a plastic layer on top of a metallic-coated glass layer, separated by spacers. When pressed, it shunts the current in the glass panel, and the X-Y coordinates pick up the location on the screen. The capacitive method uses a metallic coated glass panel, but without the plastic overlay. It senses the change in current from the charge in the pressure-applying element (finger, stylus, etc.).

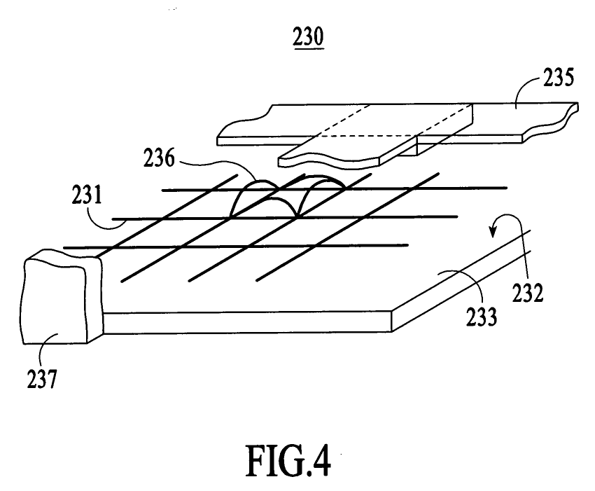

FIG. 4 illustrates another perspective view of the keyboard arrangement 230. FIG. 4 shows the molded keys 235, the curved leaf springs 236 resting on top of the support grid 231, the touch-screen 232 and the underlying LCD panel 233. Also shown is a molded side portion 237 for providing support to the support grid 231.

Although the above-disclosed embodiments are described as being employed in conjunction with clear plastic material, one of ordinary skill in art will readily recognize that any of a variety of materials could be employed while remaining within the spirit and scope of the present invention.

In one embodiment, the primary functionality of the hand-held device 200 is that of a cellular telephone. However, although the primary functionality of the hand-held device 200 is that of a cellular telephone, the hand-held device 200 has multiple functionalities. For example, the hand-held device 200 can be used as a telephone, an MP3 player, a camera, an instant messager, a calendar, etc. Accordingly, through the implementation of a keypad arrangement 230 in accordance with an embodiment, these functionalities can be accessed and utilized with relative ease.

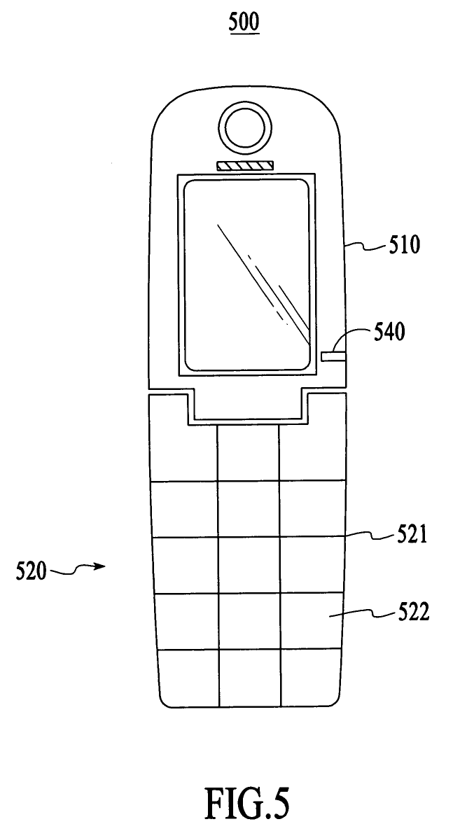

FIG. 5 is an illustration of a hand-held device configuration 500 in accordance with an embodiment. FIG. 5 shows a first LCD screen 510 and a keypad arrangement 520. The keypad arrangement 520 includes a clear, molded keypad portion 521 and an underlying second LCD screen 522. Not seen in FIG. 5 are the rigid support grid and the leaf springs. Since the molded keypad portion 521 is clear, the underlying second LCD screen 522 can be seen by the device user through the molded keypad portion 521. In an embodiment, the underlying second LCD screen 522 is a touch-screen.

Consequently, since the device user can see the underlying second LCD screen 522, a plurality of different legends can be displayed on the underlying second LCD screen 522 based on the desired functionality of the hand-held device. A “legend”, for the purposes of this patent application, is the associated display of the functionality currently being implemented by the hand-held device. The legends can be dynamically changed through software control based on context and application.

Additionally, the configuration 500 includes a function switch 530 that allows a device user to toggle between legends based on the desired functionality of the device. For example, in order for the device user to toggle between legends, he simply depresses the function switch 530. The function switch 530 can be employed through the use of permanently designated button or it could be employed through software control by displaying a “switch” symbol on the underlying second LCD screen 522 beneath the clear, molded keypad portion 521.

Also, keeping the underlying second LCD screen 522 on all the time has a tendency to consume precious battery power. Consequently, the underlying second LCD screen 522 is programmed to turn off automatically if it is not used for a predetermined amount of time. Accordingly, the configuration 500 includes a “wake up” key 540 to turn on the underlying second LCD screen 522 once the automatic turn off has taken place. In an embodiment, the wake up key 540 is a conventional key and can alternatively be used to toggle the underlying second LCD screen 522 on and off.

The following examples are sample key functionality adaptation based on context and application:

Cell Phone Functionality

A cell phone is a portable telephone that transmits to and receives signals from multiple base stations over vast geographical distances. The concept behind a cellular system is that an area is divided into a number of slightly overlapping circular “cells.” Each cell contains a base station, which is identifiable from its transmitting and receiving tower. The multiple cells combined with low power transmitters allow the same frequencies to be reused with different conversations in different cells within the same city or locale. The primary digital cell phone technologies are Time Division Multiple Access, Code Division Multiple Access and Global System for Mobile Communications.

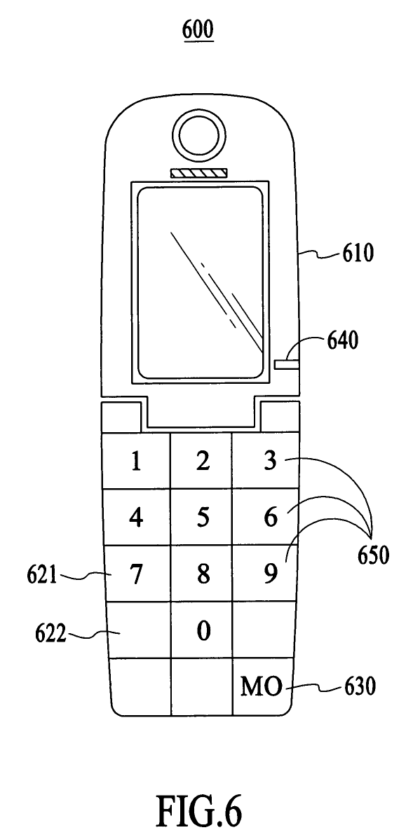

FIG. 6 illustrates a cell phone legend 600 in accordance with an embodiment. As can be seen in FIG. 6, the cell phone legend 600 includes a plurality of numbers 650. These numbers 650 are displayed via software control on the underlying second LCD 622 and can be seen through the molded keypad portion 621. Consequently, the device user can use the legend 600 in conjunction with the first LCD screen 610 to make telephone calls with the device in a normal fashion. The cell phone legend 600 also includes the function switch 630 and a wake up key 640.

MP3 Player Functionality

The MP3 player functionality relates to the playing of audio files encoded in MPEG Audio Layer 3. MPEG Audio Layer 3 is an audio compression technology that is part of the MPEG-1 and MPEG-2 specifications. Developed in Germany in 1991 by the Fraunhofer Institute, MP3 uses perceptual audio coding to compress CD-quality sound by a factor up to 12, while providing almost the same fidelity. MP3 music files are played via software or a physical player that cables to the PC for transfer.

MP3 made it feasible to download quality audio from the Web very quickly, causing it to become a worldwide auditioning system for new musicians and labels. Established bands post sample tracks from new albums to encourage CD sales, and new bands post their music on MP3 sites in order to develop an audience. MP3 players often support other audio formats such as Windows WAV and WMA.

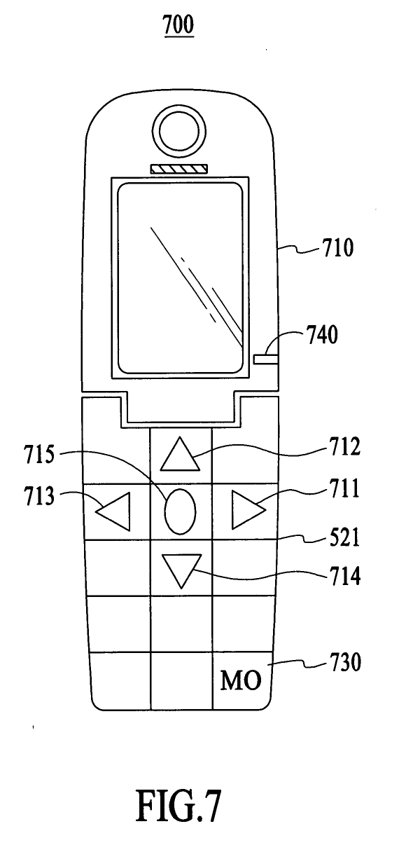

FIG. 7 illustrates a MP3 player legend 700 in accordance with an embodiment. As can be seen in FIG. 7, the MP3 player legend 700 includes a plurality of indicators 711-715. These indicators 711-715 are displayed via software control on the underlying second LCD 722 and can be seen through the molded keypad portion 721. The indicators 711-715 are subsequently utilized to the control the MP3 player functionality. For example, indicators 711 and 713 could be utilized in conjunction with the first LCD screen 710 to respectively move forward and backward through the MP3 song list while indicators 712 and 714 could be utilized to control the volume of the song being played. Indicator 715 could be utilized as an “action” button to play or pause the current song. The MP3 player legend 700 also includes the function switch 730 and the wake up key 740.

Digital Camera Functionality

A digital camera behaves more or less like a conventional point-and-shoot cameras. Unlike conventional cameras however, most digital cameras store digital images in an internal flash memory or on external memory cards, and are equipped with a liquid-crystal display (LCD) screen. Through the use of the LCD, most digital cameras operate in two modes, record and play, although some only have a record mode. In record mode, the LCD is used as a viewfinder in which the user may view an object or scene before taking a picture. In play mode, the LCD is used as a playback screen for allowing the user to review previously captured images either individually or in arrays of four, nine, or sixteen images. Digital cameras can typically be coupled with a peripheral display, such as a television set or a computer display. In this manner, the user may view the various images stored within the digital camera on a larger display.

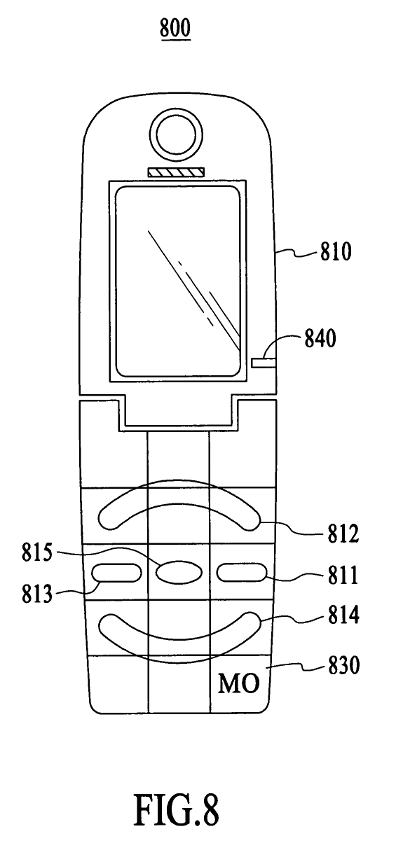

FIG. 8 illustrates a digital camera legend 800 in accordance with an embodiment. As can be seen in FIG. 8, the digital camera legend 800 includes a plurality of indicators 811-815. Here, as with the MP3 player functionality, the plurality of indicators 811-815 are utilized in conjunction with the first LCD screen 810. The indicators 811-815 are displayed via software control on the underlying second LCD 822 and can be seen through the clear, molded keypad portion 821. The indicators are subsequently utilized to the control the digital camera functionality. For example, indicators 811 and 813 could be utilized in conjunction with the first LCD screen 810 to respectively move forward and backward through the library of images stored in the device.

Indicators 812 and 814 could be utilized to rotate the current image being displayed on the first LCD screen 810. Indicator 815 could be utilized as the camera “action” button to capture and store images displayed on the first LCD screen 810 when the device is in a camera mode. The digital camera legend 800 also includes the function switch 830 and the wake up key 840.

Text Messaging Functionality

Text messaging involves sending short messages to a smart phone, pager, personal digital assistant or other handheld device. Text messaging implies sending short messages generally no more than a couple of hundred characters in length. In Europe, text messaging was popularized by the GSM cell phone system's Short Messaging Service (SMS), which supports messages of up to 160 characters.

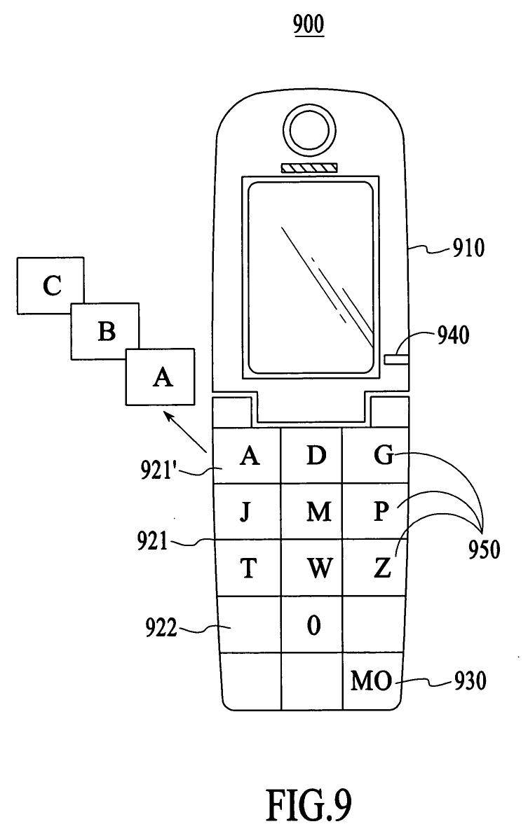

FIG. 9 illustrates a text messaging legend 900 in accordance with an embodiment. As can be seen in FIG. 9, the text messaging legend 900 includes a plurality of letters 950. These letters 950 are displayed via software control on the underlying second LCD 922 and can be seen through the clear, molded keypad portion 921. Consequently, the device user can use the legend 900 in conjunction with the first LCD screen 910 to type and send text messages in a normal fashion.

Furthermore, in an embodiment, the letters 950 can be rotated under the keypad portion 921 with each pressing of the associated key. For example, key 921′ can rotate through letters the “A, B, C” as shown in FIG. 9 with each pressing of the overlaying key. The text messaging legend 900 also includes the function switch 930 and the wake up key 940.

Although the above disclosed embodiments show a variety of legends associated with a variety of functionalities of the hand-held device, one of ordinary skill in the art will readily recognize that a variety of different legends could be employed while remaining within the spirit and scope of the present invention.

Additionally, although the primary functionality of the above described embodiment is a cell phone, one of ordinary skill in the art will readily recognize that any of variety of primary functionalities could be employed while remaining within the spirit and scope of the present invention.

A keypad arrangement for a hand-held device is disclosed. Accordingly, varying embodiments of the present invention employ a transparent keypad that functions as a lens to show an underlying touch screen LCD. As a result, the legends being displayed on the underlying LCD can be dynamically changed through software control based on the context and functionality of the desired application. Also, the transparent keypad provides the device user with the same key snap and tactile feedback of a conventional keypad. Consequently, a more user friendly interface is achieved.

Without further analysis, the foregoing so fully reveals the gist of the present invention that others can, by applying current knowledge, readily adapt it for various applications without omitting features that, from the standpoint of prior art, fairly constitute essential characteristics of the generic or specific aspects of this invention. Therefore, such applications should and are intended to be comprehended within the meaning and range of equivalents of the following claims. Although this invention has been described in terms of certain embodiments, other embodiments that are apparent to those of ordinary skill in the art are also within the scope of this invention, as defined in the claims which follow.

What is claimed:

1. A keypad arrangement for a device comprising:
a molded portion;
an underlying display portion coupled to the molded portion capable of dynamically displaying a plurality of different legends whereby each of the plurality of legends is associated with at least one functionality of the device.

2. The keypad arrangement of claim 1 wherein the molded portion is comprised of a transparent material.

3. The keypad arrangement of claim 1 wherein the underlying display portion comprises liquid crystal display.

4. The keypad arrangement of claim 1 wherein the at least one functionality of the device is a phone functionality.

5. The keypad arrangement of claim 1 wherein the at least one functionality of the device is an MP3 player functionality.

6. The keypad arrangement of claim 1 wherein the at least one functionality of the device is a calculator functionality.

7. The keypad arrangement of claim 1 wherein the at least one functionality of the device is a camera functionality.

8. The keypad arrangement of claim 1 wherein the device includes a key for turning the underlying display portion on and off.

9. The keypad arrangement of claim 1 wherein the molded portion is coupled to the underlying display portion via a rigid support grid.

10. The keypad arrangement of claim 2 wherein the molded portion is comprised of a plastic material.

11. The keypad arrangement of claim 3 wherein the liquid crystal display comprises a touch-screen type liquid crystal display.

12. The keypad arrangement of claim 9 wherein the rigid support grid includes a spring portion for key snap and tactile feedback.

13. A hand-held device comprising:
a keypad portion wherein the keypad portion comprises,
a transparent molded portion; and
an underlying liquid crystal display coupled to the transparent molded portion capable of dynamically displaying a plurality of different legends whereby each of the plurality of legends is associated with at least one functionality of the hand-held device; and
a processor coupled to the keypad portion wherein the processor is responsive to the keypad portion.

14. The hand-held device of claim 13 wherein the at least one functionality of the hand-held device is a phone functionality.

15. The hand-held device of claim 13 wherein the at least one functionality of the hand-held device is an MP3 player functionality.

16. The hand-held device of claim 13 wherein the at least one functionality of the hand-held device is a calculator functionality.

17. The hand-held device of claim 13 wherein the at least one functionality of the hand-held device is a camera functionality.

18. The hand-held device of claim 13 wherein the hand-held device includes a key for turning the underlying liquid crystal display on and off.

19. The hand-held device of claim 13 wherein the transparent molded portion is coupled to the underlying liquid crystal display via a rigid support grid.

20. The hand-held device of claim 14 wherein the transparent molded portion is comprised of a plastic material.

21. The hand-held device of claim 15 wherein the underlying liquid crystal display comprises a touch-screen type liquid crystal display.

22. The hand-held device of claim 19 wherein the rigid support grid includes a spring portion for key snap and tactile feedback.

23. A reconfigurable interface for a hand-held device comprising:
a keypad portion; and
display means coupled to the keypad portion wherein the display means is capable of dynamically displaying a plurality of different legends whereby each of the plurality of legends is associated with at least one functionality of the hand-held device.

24. The reconfigurable interface of claim 23 wherein the at least one functionality of the hand-held device is a phone functionality.

25. The reconfigurable interface of claim 23 wherein the at least one functionality of the hand-held device is an MP3 player functionality.

26. The reconfigurable interface of claim 23 wherein the at least one functionality of the hand-held device is a digital camera functionality.

27. The reconfigurable interface of claim 23 wherein the display means comprises a touch-screen type liquid crystal display.

28. The reconfigurable interface of claim 27 wherein the display means further comprises a rigid support grid that includes a spring portion for key snap and tactile feedback.
